(19) United States
(12) Patent Application Publication
(10) Pub. No.: US 2014/0365969 A1
(43) Pub. Date: Dec. 11, 2014

(54) METHOD AND APPARATUS FOR PROVIDING A USER INTERFACE OF ELECTRONIC DEVICE

(71) Applicant: SAMSUNG ELECTRONICS CO., LTD., Gyeonggi-do (KR)

(72) Inventors: Jiwoo Lee, Gyeongsangbuk-do (KR); Soohyung Kim, Gyeonggi-do (KR)

(21) Appl. No.: 14/301,275

(22) Filed: Jun. 10, 2014

(30) Foreign Application Priority Data
Jun. 10, 2013 (KR) 10-2013-0065940

(51) Int. Cl. G06F 3/0482; G06F 3/0488; G06F 3/0481

(52) U.S. Cl. CPC G06F 3/0482; G06F 3/04817; G06F 3/0488
USPC 715/834

(57) ABSTRACT

A method and an apparatus efficiently display and control a plurality of pieces of content in a user interface of an electronic device which provides the user interface.

The method includes: receiving a content list display request; and outputting a content list screen on which icons corresponding to a plurality of pieces of content are arranged and displayed in a planar spiral structure.

### CROSS-REFERENCE TO RELATED APPLICATION(S) AND CLAIM OF PRIORITY

The present application is related to and claims priority from and the benefit under 35 U.S.C. §119(a) of Korean Patent Application No. 10-2013-0065940, filed on Jun. 10, 2013, which is hereby incorporated by reference for all purposes as if fully set forth herein.

### TECHNICAL FIELD

The present disclosure relates to a method and an apparatus for providing a user interface, and more particularly, to a method and an apparatus for efficiently displaying and controlling a plurality of pieces of content in a user interface of an electronic device which provides the user interface.

### BACKGROUND

With the remarkable development of information communication technology and a semiconductor technology, the spread and use of electronic devices are rapidly increasing. In particular, recent electronic devices have reached a mobile convergence stage of encompassing an area of other terminals without being confined to their own traditional unique areas. For example, mobile communication terminals provide various functions such as a TV viewing function (e.g., mobile broadcasting such as Digital Multimedia Broadcasting (DMB) or Digital Video Broadcasting (DVB)), a music reproduction function (e.g., MPEG Audio Layer-3 (MP3)), a photography mode, a data communication function, an internet access function, and a short range wireless communication function in addition to a general communication functions such as voice calls or message transmission/reception.

Meanwhile, the recent electronic devices provide a function of storing various pieces of content, for example, document data, image data, video data, audio data, and the like. The electronic devices may store hundreds to thousands of pieces of content.

### SUMMARY

As it is possible to store hundreds to thousands of data as described above, the conventional electronic devices display the stored content by using a thumbnail image. For example, the conventional electronic devices display a content list by arranging thumbnail images of the content in multiple rows and columns. However, the electronic devices may have restricted screen sizes due to the portability thereof. When the size of the screen is restricted as described above, the electronic devices may have a limitation in the number of thumbnail images which can be displayed on one screen. In this case, users of the electronic devices may perform a scroll operation to identify content which is not displayed on the screen. However, when the electronic devices store hundreds to thousands of pieces of content, the users of the electronic devices should perform the scroll operation a plurality of times. In other words, a user interface of the conventional electronic devices has a limitation in the number of pieces of content displayed. on the one screen, thereby inconveniencing the users in managing the content.

To address the above-discussed deficiencies, it is a primary object to provide a method and an apparatus for providing a user interface of an electronic device, which can provide a user interface for efficiently displaying a plurality of pieces of content on one screen and controlling the displayed content.

In accordance with one aspect of the present disclosure, a method of providing a user interface of an electronic device is provided. The method includes: receiving a content list display request; and outputting a content list screen on which icons corresponding to a plurality of pieces of content are arranged and displayed in a planar spiral structure.

In accordance with another aspect of the present disclosure, an apparatus for providing a user interface of an electronic device is provided. The apparatus includes: a storage unit that stores a plurality of pieces of content; a display unit that displays an image; and a controller that controls the display unit to output a content list screen on which icons corresponding to the plurality of pieces of content are arranged and displayed in a planar spiral structure, when displaying of a content list is requested.

As described above, the present disclosure provides the method and the apparatus for providing the user interface of the electronic device, which can efficiently display a plurality of pieces of content on one screen by arranging icons (thumbnail images) corresponding to the content in a planar spiral structure and gradually reducing a size of the icons. Further, according to various embodiments of the present disclosure, controls such as enlargement/reduction of a content list screen, a movement of thumbnail images (icons), reconfiguration of the content list screen, and a selection of a plurality of pieces of content can be easily performed through a touch event detected on the content list screen.

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 is a block diagram illustrating a configuration of an electronic device according to an embodiment of the present disclosure;

FIG. 2 is a flowchart illustrating a method of providing a user interface of an electronic device according to an embodiment of the present disclosure;

FIGS. 3A to 3C illustrate content list screens of an electronic device according to an embodiment of the present disclosure;

FIG. 3D illustrates a content list screen of an electronic device according to another embodiment of the present disclosure;

FIG. 4 illustrates a method of arranging content of an electronic device according to an embodiment of the present disclosure;

FIG. 5 illustrates an example of a screen for explaining a method of enlarging/reducing a content list screen according to an embodiment of the present disclosure;

FIG. 6A illustrates an example of a screen for explaining a method of enlarging a content list screen according to another embodiment of the present disclosure;

FIG. 6B illustrates an example of a screen for explaining a method of reducing a content list screen according to another embodiment of the present disclosure;

FIGS. 7A and 7B illustrate examples of a screen for explaining a method of moving content according to embodiments of the present disclosure;

FIG. 8 illustrates a method of moving content according to another embodiment of the present disclosure;

FIG. 9 illustrates a method of reconfiguring a content list screen by using a multi-touch according to an embodiment of the present disclosure;

FIG. 10 illustrates a method of selecting a plurality of pieces of content on a content list screen according to an embodiment of the present disclosure; and

FIG. 11 illustrates a method of displaying a content list in conjunction with another electronic device according ₜo an embodiment of the present disclosure.

### DETAILED DESCRIPTION

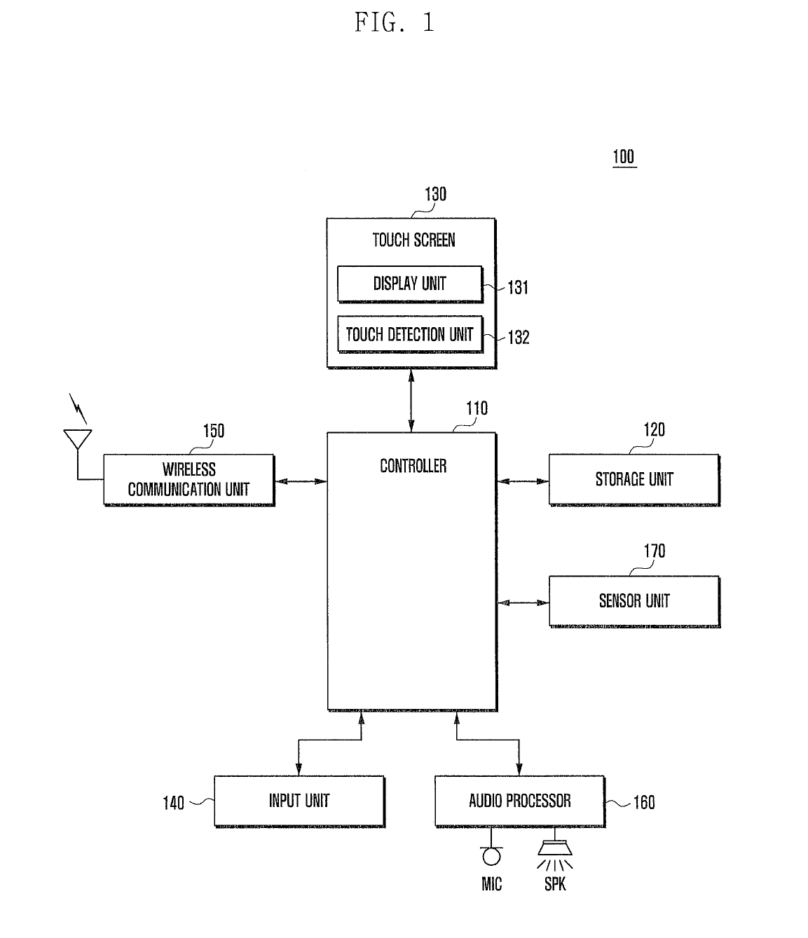

FIGS. 1 through 11, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device. Hereinafter, embodiments of the present disclosure will be described in detail with reference to the accompanying drawings. It should be noted that the same elements will be designated by the same reference numerals although they are shown in different drawings. Further, detailed descriptions related to well-known functions or configurations capable of making subject matters of the present disclosure unnecessarily obscure will be omitted.

Meanwhile, exemplary embodiments of the present disclosure shown and described in this specification and the drawings correspond to specific examples presented in order to easily explain technical contents of the present disclosure, and to help comprehension of the present disclosure, but are not intended to limit the scope of the present disclosure. It is obvious to those skilled in the art to which the present disclosure pertains that other modified embodiments on the basis of the spirit of the present disclosure besides the embodiments disclosed herein can be carried out.

Prior to a detailed description, an electronic device may include a mobile communication electronic device, a smart phone, a tablet Personal Computer (PC), a hand-held PC, a Portable Multimedia Player (PMP), a Personal Digital Assistant (PDA), and the like.

FIG. 1 is a block diagram illustrating a configuration of an electronic device according to various embodiments of the present disclosure.

Referring to FIG. 1, an electronic device 100 according to various embodiments of the present disclosure may include a controller 110, a storage unit 120, a touch screen 130, an input unit 140, a wireless communication unit 150, an audio processor 160, and a sensor unit 170. The touch screen 130 may include a display unit 131 and a touch detection unit 132.

The sensor unit 170 may detect a movement of the electronic device 100. For example, the sensor unit 170 may detect a movement of the electronic device 100 away from a user and a movement of the electronic device 100 toward the user. Such a sensor unit 170 may be configured with an acceleration sensor, a motion sensor, a gravity sensor, a geo-magnetic sensor, and the like.

The audio processor 160 may be connected with a speaker SPK for outputting an audio signal transmitted or received during a communication, an audio signal included in a received message, an audio signal according to reproduction of audio data (or an audio file) stored in the storage unit 120 and an audio signal included in video data (or a video file), and with a microphone MIC for collecting a user's voice or other audio signals. The audio processor 160 may provide a sound effect according to providing of a User Interface (UI) of the electronic device 100. For example, the audio processor 160 may provide a sound effect which informs the user that it is not possible to enlarge/reduce a screen or to move an icon.

The wireless communication unit 150 may support a wireless communication function of the electronic device 100. For example, the wireless communication unit 150 may include a short-range wireless communication module, such as a Bluetooth module, a ZigBee module, a Near Field Communication (NFC) module, or a Wireless Fidelity (Wi-Fi) module, when the electronic device 100 supports a short-range wireless communication, and may include a mobile communication module when the electronic device 100 supports a mobile communication function (for example, a function of a mobile communication with the 3G or 4G standards). Meanwhile, the wireless communication unit 150 may receive content from a server or other electronic devices, or may transmit content to the server or the other electronic devices. Further, the wireless communication unit 150 may transmit the whole or a portion of the screen of the electronic device 100 to other electronic devices. At this time, the screen maybe transmitted in the same form as that of the electronic device 100 or in a changed form to the other electronic devices.

The input unit 140 generates a key signal related to user settings and function control of the electronic device 100, and transfers the generated key signal to the controller 110. To this end, the input unit 140 may include various input keys and function keys for receiving numeral or text information and setting various functions. The function keys may include a direction key, a side key, and a shortcut key, which are set to execute particular functions. The input unit 140 may be configured with any one or a combination of input means such as a qwerty keypad, a 3*4 keypad, a 4*3 keypad, a ball joystick, an optical joystick, a wheel key, a touch key, a touch pad, a touch screen, and the like. Meanwhile, the input unit 140 may also include only some function keys such as a volume key, a power key, a menu key, a cancellation key, a home key, and the like when the electronic device 100 supports a full touch screen. For example, the input unit 140 according to various embodiments of the present disclosure may generate various input signals for controlling procedures such as displaying a content list screen, enlargement/reduction of a screen, movement of an icon, reconfiguration of a screen, and a selection of a plurality of icons, and may transmit the generated input signals to the controller 110.

The touch screen 130 may perform an input function and a display function. To this end, the touch screen 130 may include the display unit 131 and the touch detection unit 132.

The display unit 131 displays information input by a user or information to be provided to the user as well as various menus of the electronic device 100. The display unit 131 may be formed with a Liquid Crystal Display (LCD), an Organic Light Emitted Diode (OLED), an Active Matrix Organic Light Emitted Diode (AMOLED), or the like. The display unit 131 may provide various screens according to use of the electronic device 100, for example, a home screen, a menu screen, a phone-call screen, and the like. For example, the display unit 131 according to the embodiment of the present disclosure may display a content list screen on which a plurality of pieces of content are arranged and displayed in a planar spiral structure, and a screen according to a control signal input through the content list screen. A detailed description of the various screens will be given below with reference to the following exemplary drawings of a screen.

The touch detection unit 132 is a device for providing an input function, and may generate a touch event and transmit the generated touch event to the controller 110 when a touch input device such as a user's finger, a stylus pen, or an electronic pen contacts or approaches the touch detection unit. Specifically, the touch detection unit 132 may detect an occurrence of a touch event through a change in physical properties (for example, a capacitance or a resistance value) according to contact or proximity of the touch input device, and may transfer the occurring touch event type (e.g. a tap, a touch movement (a drag and a flick), a long touch, a double-touch, multi-touch, etc.) and touch location information to the controller 110. The drag means a movement of a touch, having instantaneous acceleration smaller than a reference value, from the first touched point, and the flick means a movement of a touch, having acceleration of a reference value or more, from the first touched point. The touch detection unit 132 as described above is obvious to those skilled in the art to which the present disclosure pertains, and thus, a detailed description thereof will be omitted. Meanwhile, the touch detection unit 132 according to the embodiments of the present disclosure may detect various touch signals for controlling procedures such as displaying a content list screen, enlargement/reduction of a screen, movement of an icon, reconfiguration of a screen, and a selection of a plurality of icons, and may transmit the detected touch signals to the controller 110.

The storage unit 120 may store application programs for executing other optional functions, such as a sound reproduction function, an image or video reproduction function, and a broadcast reproduction function, as well as an Operating System (OS) of the electronic device 100. Further, the storage unit 120 may store various types of data, such as video data, game data, audio data, and movie data. For example, the storage unit 120 according to various embodiments of the present disclosure may store a user interface control program. The user interface control program may include a routine for arranging a plurality of pieces of content in a planar spiral structure, a routine for controlling enlargement/reduction of a screen, a routine for controlling a movement of an icon, a routine for controlling reconfiguration of a screen according to a multi-touch input, a routine for controlling the performance of particular functions (a slide show function, a group generation function, and the like) for a plurality of selected icons, and a routine for controlling transmission of a screen to other electronic devices. The routine for arranging the content in the planar spiral structure may include a routine for calculating the size of icons and arranging the icons according to the calculated size thereof.

The storage unit 120 may store the number of loops (e.g., four) included in a content list screen. Further, the storage unit 120 may store a gesture (e.g., a clockwise or counterclockwise rotation gesture) for a movement of all icons.

The controller 110 may control overall operations of the electronic device 100 and a signal flow between internal blocks of the electronic device 100, and may perform a data processing function for processing data. For example, the controller 110 may be configured with a Central Processing Unit (CPU), an application processor, and the like. The controller 110 may be configured with a single core processor or a multi-core processor.

The controller 110 may control the display unit 131 to output a content list screen on which a plurality of pieces of content are arranged in a planar spiral structure, when there is a request for displaying of a content list. At this time, the content may be displayed as an icon (e.g., a thumbnail image). The content list screen may be configured with a plurality of loops, in which case icons located in each of the loops have the same size, and the icons maybe reduced in size as the loop is located to be closer to a center of the content list screen.

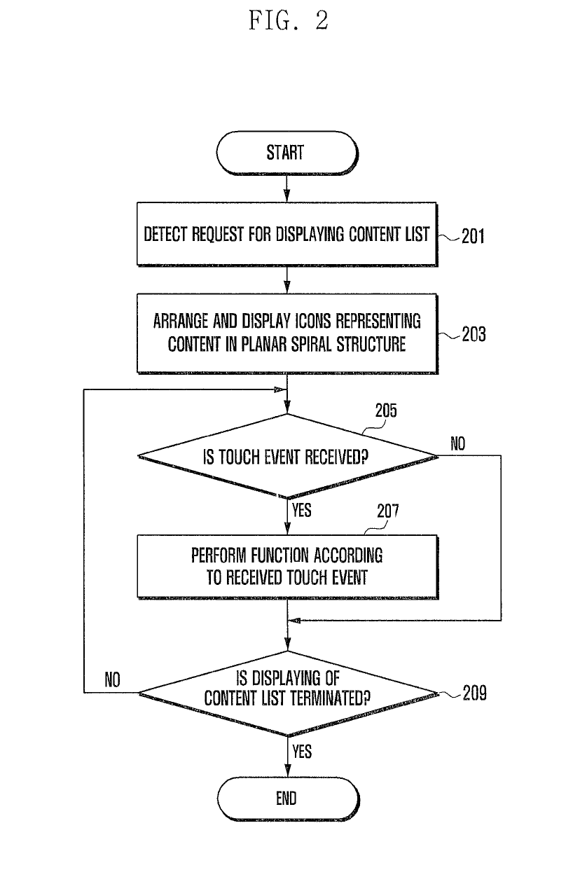

The controller 110 may control procedures such as enlargement/reduction of the content list screen, movement of an icon, reconfiguration of a screen, and a selection of a plurality of icons, according to a control signal input through the content list screen. A detailed description thereof will be given below with reference to FIGS. 2 to 11.

Meanwhile, the electronic device 100 may further selectively include components having additional functions, such as a camera module for photographing an image/video or performing a video call, a broadcast reception module for receiving a broadcast, and a digital sound source reproduction module including an MP3 module, although they are not illustrated in FIG. 1. While all structural elements cannot be listed since they may be variously modified according to the convergence trend of digital devices, the electronic device 100 according to the various embodiments of the present disclosure may further include structural elements at an equivalent level to the aforementioned components.

FIG. 2 is a flowchart illustrating a method of providing a user interface of an electronic device according to an embodiment of the present disclosure.

Referring to FIG. 2, a controller 110 of the electronic device 100 according to the embodiment of the present disclosure may detect a request for displaying a content list, in operation 201. Thereafter, the controller 110 may arrange icons (e.g., thumbnail images) representing content in a planar spiral structure, in operation 203. On the content list screen, icons having a first size are arranged in a loop form (hereinafter, referred to as a first loop) along edges of a content display area, and icons having a second size smaller than the first size are arranged in a loop form (hereinafter, referred to as a second loop) along an inside of the first loop. The content list screen may include a predetermined number of loops (e.g., four loops). The number of loops on the content list screen may be set by a user or a manufacturer. At this time, the icons included in each of the loops have the same size, and may be arranged so as not to overlap each other. Further, the plurality of loops include the same number of icons. For example, the content list screen is configured with a plurality of loops, and as the loops are located to be closer to a center of the content list screen, icons included therein may have a smaller size.

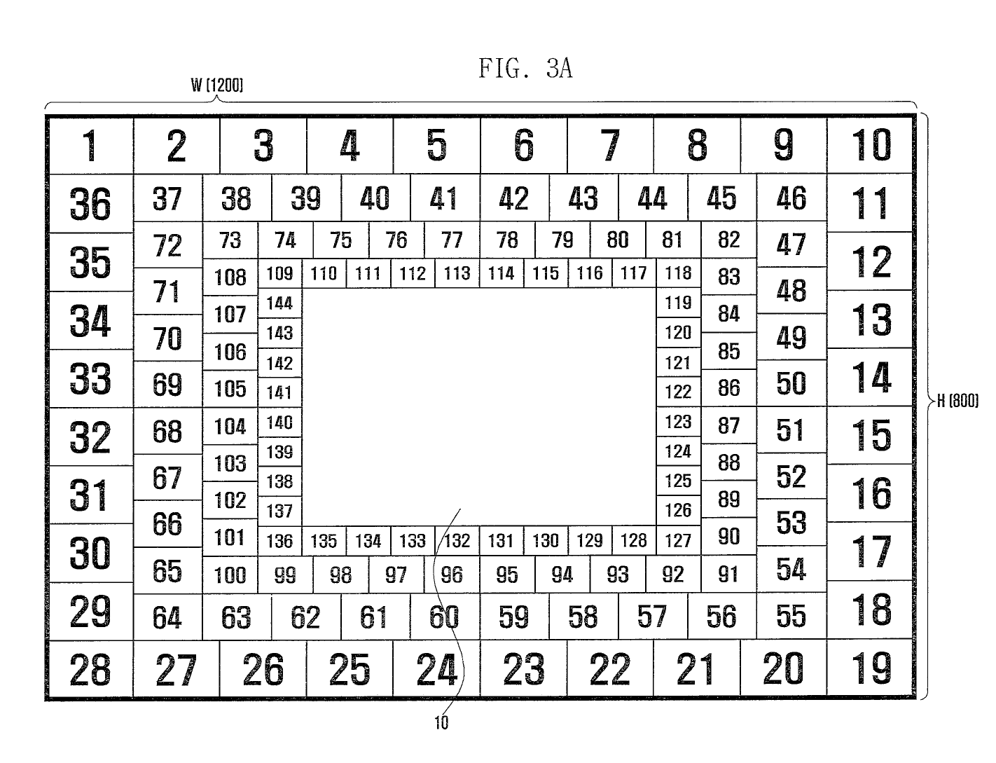

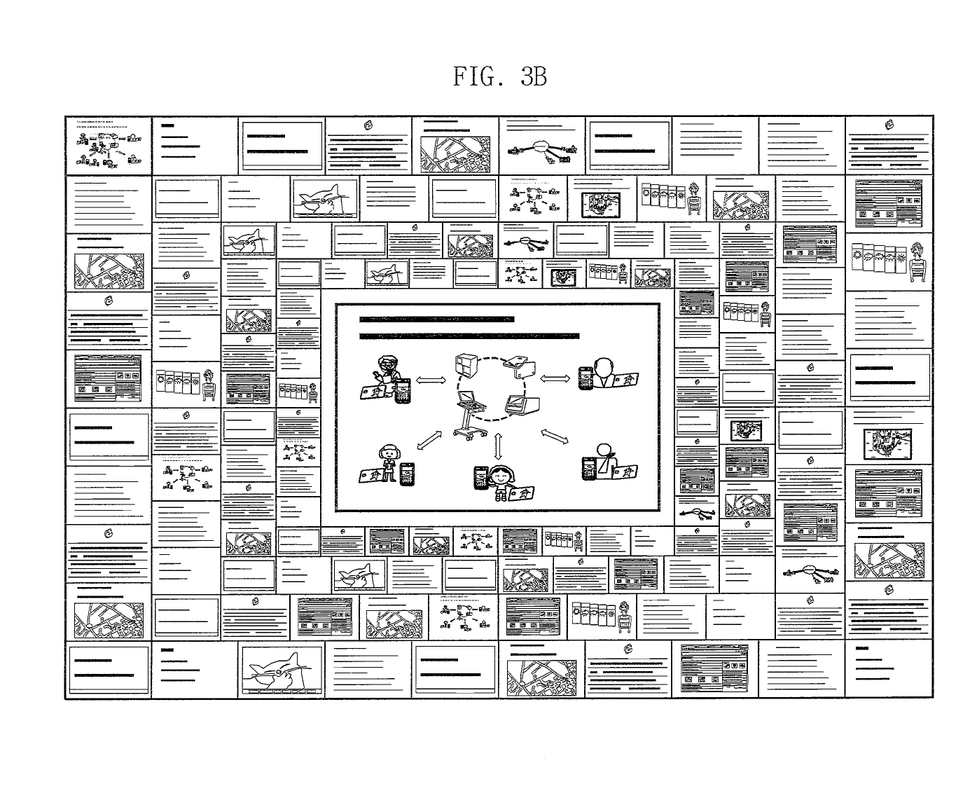

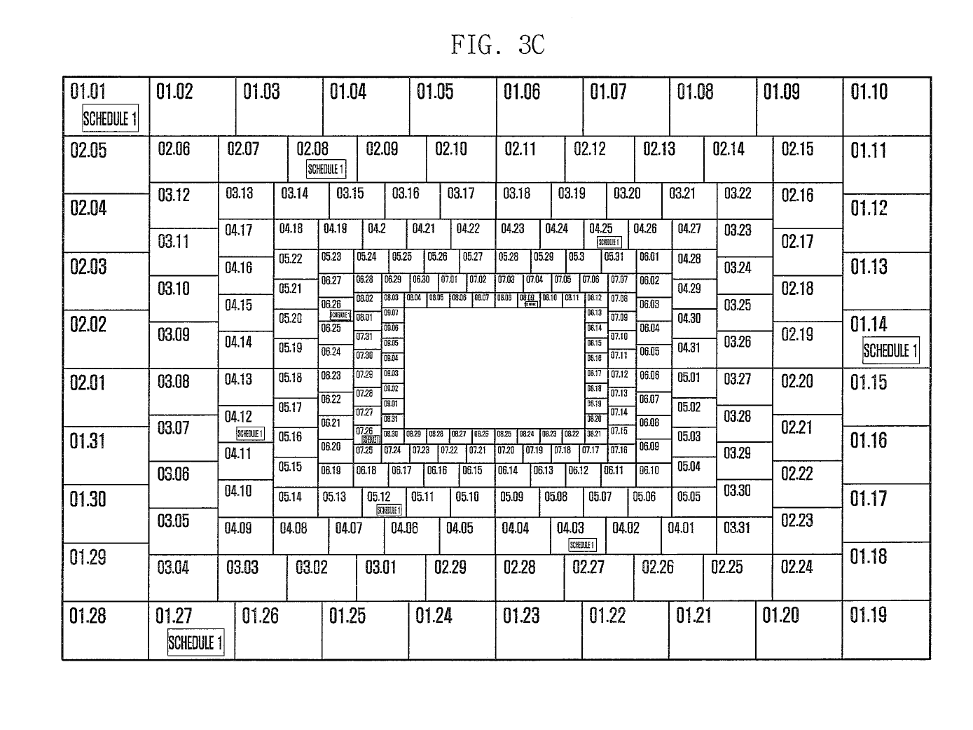

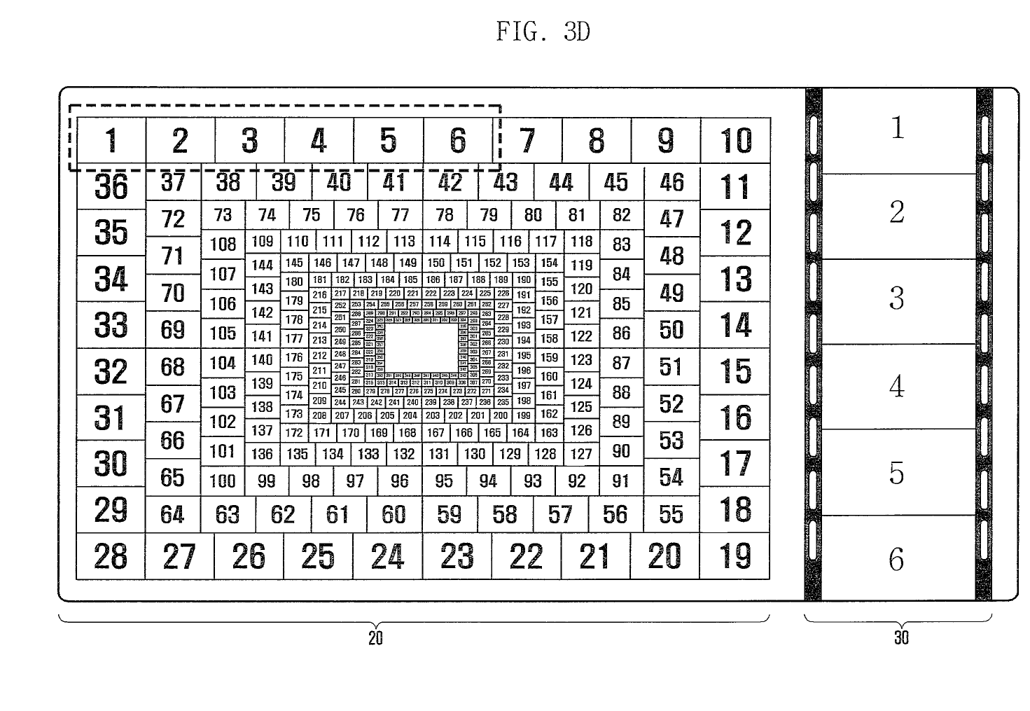

Meanwhile, the controller 110 may display content to form a predetermined number of loops, and thereafter, may display representative content in an empty central area of the content list screen. For example, the representative content may be content corresponding to an icon selected by a user or an icon located at an upper left end of the content list screen. Such a content list screen will be described below in detail with reference to FIGS. 3A to 3D.

The controller 110 may identify in operation 205 whether a pre-defined touch event is received through the content list screen. The pre-defined touch event may be a touch event for performing functions such as enlargement/reduction of the screen, movement of the icons, reconfiguration of the screen, and a selection of a plurality of pieces of content.

When the touch event is not received, the controller 110 may proceed to operation 209 which will be described below. On the other hand, when the touch event is received, the controller 110 may proceed to operation 207 and may perform a function according to the received touch event. As described above, the controller 110 may perform the enlargement/reduction of the screen, the movement of an icon, the reconfiguration of the screen, or the selection of the plurality of pieces of content.

The controller 110 may identify in operation 209 whether there is a request for terminating the displaying of the content list. When there is no request for terminating the displaying of the content list, the controller 110 may return to operation 205, and may repeat the aforementioned operations. On the other hand, when there is the request for terminating the displaying of the content list, the controller 110 may terminate the displaying of the content list.

Meanwhile, although the performing of the functions is controlled through the touch event on the content list screen, the present disclosure is not limited thereto. For example, in another embodiment of the present disclosure, the performing of the functions may also be controlled through an input device such as a mouse, a keypad, and the like. Furthermore, although the icons are arranged and displayed in the planar spiral structure when the displaying of the content list is requested, the content list display mode according to the embodiment of the present disclosure maybe provided together with a general mode for displaying the list by listing existing names and a matrix display mode for displaying thumbnail images having the same size in multiple rows and columns, in another embodiment of the present disclosure. In this case, the electronic device 100 may provide an option menu capable of displaying the content list in a display mode selected from the three display modes and changing the display mode of the content list.

FIGS. 3A to 3C illustrate content list screens of an electronic device according to an embodiment of the present disclosure.

Referring to FIGS. 3A to 3C, on the content list screens according to the embodiment of the present disclosure, icons (e.g., thumbnail images) corresponding to a plurality of pieces of content may be arranged in a planar spiral structure. Each of the content list screens may include a plurality of loops. At this time, each of the loops may have the same number of icons. For example, as illustrated in FIG. 3A, the content list screen may include four loops, in which a first loop may include 1st to 36th icons, a second loop may include 37th to 72th icons, a third loop may include 73th to 108th icons, and a fourth loop may include 109th to 144th icons. The loop located to be closer to the center of the content list screen may be configured with smaller-sized icons.

Specifically, when a screen for displaying content has a full size of “W (width)*H (height)” and “n (width)*m (height)” icons are displayed, icons included in a first loop have a size of “W/n*H/m” and icons included in a second loop have a size of “(W/n*{(n−2)/n}*H/m*{(m−2)/m})”. As described above, the icons may be reduced in size whenever the loop is changed. For example, when it is assumed that the content list display area has a size of 1200*800 and 10 icons are displayed in rows and columns, 36 icons having a first size of 120*80, 36 icons having a second size of 96*64 (80% of the first size), 36 icons having a third size of 76*51 (80% of the second size), and 36 icons having a fourth size of about 61*41 (80% of the third size), namely, a total of 144 (=36*4) icons may be displayed on the content list screen. Meanwhile, when the content list screen has 10 loops, 360 (=36*10) icons may be displayed on the content list screen. Meanwhile, the conventional electronic device displaying thumbnail images having the same size in multiple rows and columns may display 100 (=10*10) icons having the first size of 120*80. As described above, in the embodiment of the present disclosure, the plurality of icons may be efficiently displayed without use of the whole content display area.

The content list screen may include a representative content display area 10. The representative display area 10 may be the area left over after the plurality of icons are arranged and displayed in the planar spiral structure. The representative content maybe content corresponding to an icon selected by a user or content corresponding to an icon at a pre-defined location (e.g., an upper left end of the content list screen, namely, a location corresponding to the No. 1 icon of FIG. 3A).

In various embodiments of the present disclosure, a list of content supporting a preview, such as a photo, a video, an e-book, a calendar, a schedule, a document, and the like, maybe efficiently displayed through the content list display method described above with reference to FIG. 3A. For example, as illustrated in FIG. 313 or 3C, the electronic device 100 may arrange and display thumbnail images corresponding to documents, or a calendar and schedule information in a planar spiral structure.

FIG. 3D illustrates a content list screen of an electronic device according to another embodiment of the present disclosure.

Referring to FIG. 3D, the content list screen according to another embodiment of the present disclosure may include a first area 20 and a second area 30. Icons may be arranged and displayed in a planar spiral structure in the first area 20 as described above with reference to FIG. 3A, and some of the icons in the first area 20 may be displayed in a line in the second area 30 similarly to the related art. At this time, the icons displayed in the second area 30 may have a size larger than that of the icons displayed in the first area 20. For example, first to sixth icons in the first area 20 may be displayed lengthwise in the second area 30. When a scroll event occurs in the first area 20, the list in the second area 30 may also be scrolled to correspond to the scroll event in the first area 20. Alternatively, when a scroll event occurs in the second area 30, the list in the first area 20 may also be scrolled to correspond to the scroll event in the second area 30. Another embodiment of the present disclosure may be employed for an electronic device having a relatively large-sized screen.

In the aforementioned another embodiment of the present disclosure, a plurality of pieces of content maybe displayed through the first area 20, and particular icons may be enlarged and displayed through the second area 30. For example, a user may rapidly identify schematic information on a plurality of pieces of content through the first area 20 and thus, may easily search for desired content, and the selected content may be more specifically identified through the second area 30.

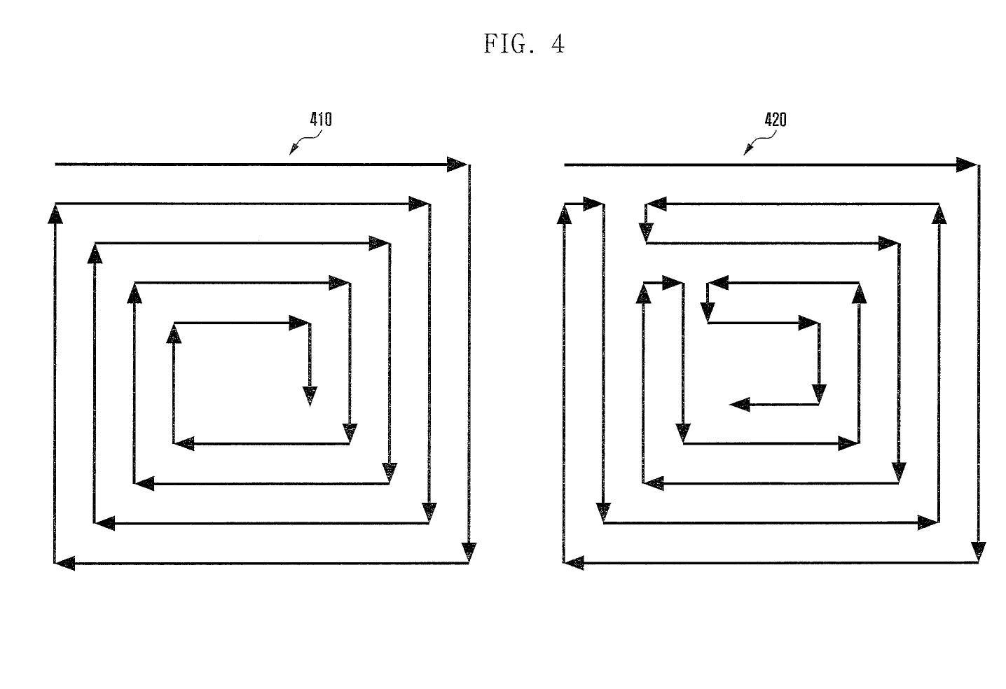

FIG. 4 illustrates a method of arranging content of an electronic device according to an embodiment of the present disclosure.

Referring to FIG. 4, an electronic device 100 according to an embodiment of the present disclosure may arrange and display icons in a clockwise direction (hereinafter, referred to as a normal arrangement) as illustrated in the drawing indicated by a reference numeral 410. Alternatively, as illustrated in the drawing indicated by a reference numeral 420, the electronic device 100 may arrange and display icons included in an odd number of loops (loops 1, 3, and 5) in a clockwise direction, and may arrange and display icons included in an even number of loops (loops 2 and 4) in a counterclockwise direction (hereinafter, referred to as an abnormal arrangement). The icons may be arranged according to a selected arrangement order (time, name, size, and the like) through the normal arrangement scheme or the abnormal arrangement scheme. For example, the electronic device 100 may arrange icons corresponding to recent content on the outside, and may dispose icons corresponding to older content on the inside. Furthermore, the electronic device 100 may arrange current schedules on the outside and past or future schedules on the inside.

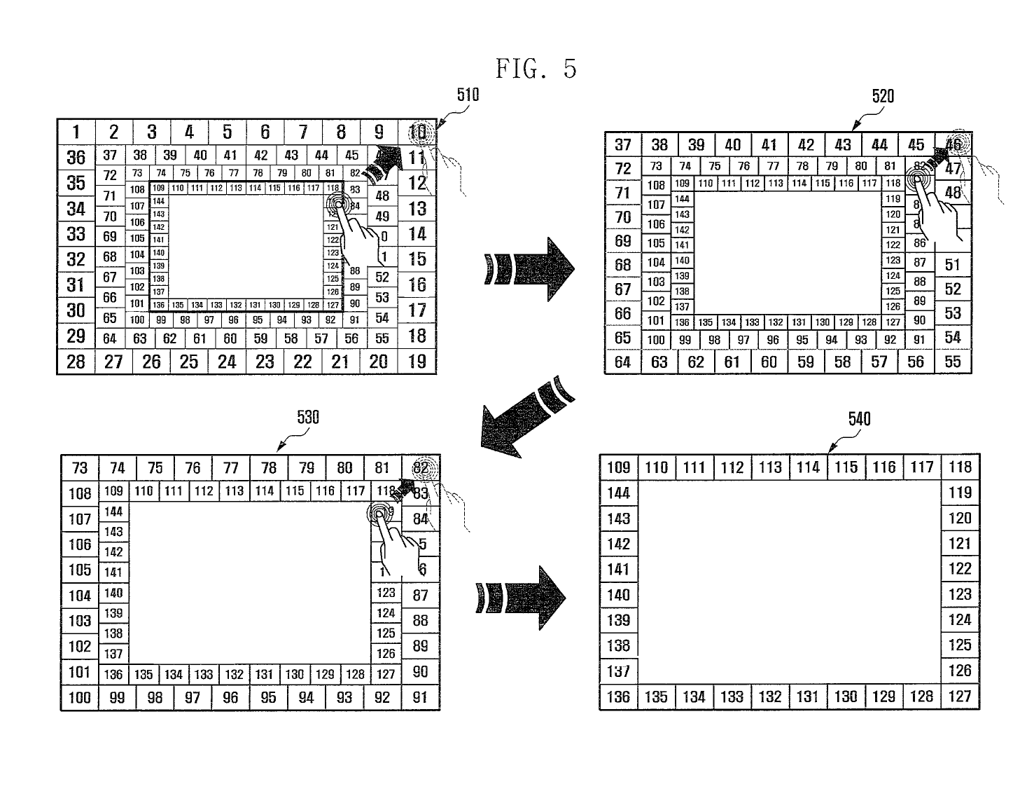

FIG. 5 illustrates an example of a screen for explaining a method of enlarging/reducing a content list screen according to an embodiment of the present disclosure.

Referring to FIG. 5, a controller 110 of an electronic device 100 according to an embodiment of the present disclosure may detect the occurrence of a touch movement event in a diagonal direction from the inside to the outside of the content list screen (hereinafter, referred to as an enlargement event) as illustrated in the drawing indicated by a reference numeral 510. Thereafter, the controller 110 may control a display unit 131 to enlarge the screen as illustrated in the drawing indicated by a reference numeral 520. For example, the controller 110 may move icons (37th to 144th icons) located in second and fourth loops to first and third loops in the drawing indicated by the reference numeral 510. At this time, it can be seen that icons (1st to 36th icons) located in the first loop in the drawing indicated by the reference numeral 510 have been removed from the content list screen. The removed icons (the 1st to 36th icons) may be temporarily stored in a virtual space, and maybe restored when a reduction event to be described below occurs.

The controller 110 may control the display unit 131 to enlarge the screen stepwise in correspondence to the enlargement event, as illustrated in the drawings indicated by reference numerals 520, 530, and 540. At this time, a representative content display area 10 may be increased in size to correspond to the enlargement of the screen, as illustrated in the drawings indicated by reference numerals 510 to 540.

Meanwhile, in FIG. 5, the number of loops is gradually decreased at a time of the enlargement event. This is because it is assumed that the last icon is displayed in the innermost loop. For example, it is assumed in FIG. 5 that a 144th icon is the last icon. On the other hand, in a case in which the 144th icon is not the last icon, the controller 110 may maintain the number of loops and may display icons subsequent to the 144th icon in the innermost loop, when the screen is enlarged. For example, when the screen is enlarged in the drawing indicated by the reference numeral 510, the controller 110 may control such that the icons subsequent to the 144th icon are displayed on an inside of the third loop in the same state as in the drawing indicated by the reference numeral 520, thereby maintaining the four loops.

Furthermore, in FIG. 5, the screen is enlarged at the same rate in correspondence to the enlargement event. However, the present disclosure is not limited thereto. For example, in another embodiment of the present disclosure, an enlargement rate of the screen may be different according to the movement distance of the touch. For example, the electronic device 100 may move the second loop to a location of the first loop when the movement distance of the touch is larger than or equal to a diagonal length between the first loop and the second loop and is smaller than a diagonal length between the first loop and the third loop, and the electronic device 100 may move the icons in the third loop to the location of the first loop and may enlarge the screen when the movement distance of the touch is larger than or equal to the diagonal length between the first loop and the third loop.

Furthermore, the electronic device 100 may move icons located in a loop corresponding to the first touched point at the time of the enlargement event to a loop corresponding to a point where the touch is released. For example, the electronic device 100 may move the icons located in the fourth loop to a location of the second loop when a touch is made on the fourth loop area, moved to the second loop area, and then, is released. At this time, the electronic device 100 does not have to calculate the movement distance of the touch.

Meanwhile, the enlargement of the screen has been described above. On the other hand, the electronic device 100 may reduce the screen when a touch movement event in a diagonal direction from the outside to the inside of the content list screen (hereinafter, referred to as a reduction event) is received. The controller 110 may reduce the screen at the same rate in correspondence to the reduction event, at a different rate according to the movement distance of the touch, or with respect to a touch start location and a touch release location.

Furthermore, although the screen is enlarged or reduced through the touch event in the diagonal direction in FIG. 5, the present disclosure is not limited thereto. For example, in another embodiment of the present disclosure, the screen may be enlarged or reduced according to a movement of the electronic device 100 which is detected through a sensor unit 170. As an example, the controller 110 may reduce the screen when a movement of the electronic device 100 away from a user is detected through the sensor unit 170, and may enlarge the screen when a movement of the electronic device 100 toward the user is detected from the sensor unit 170.

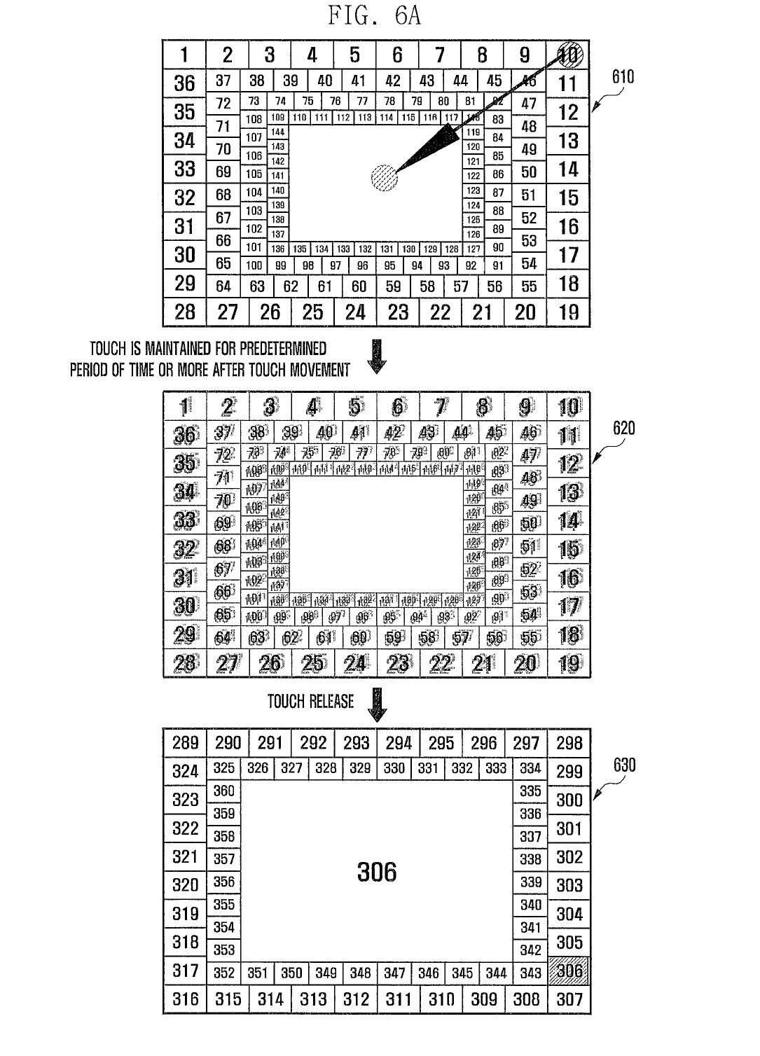

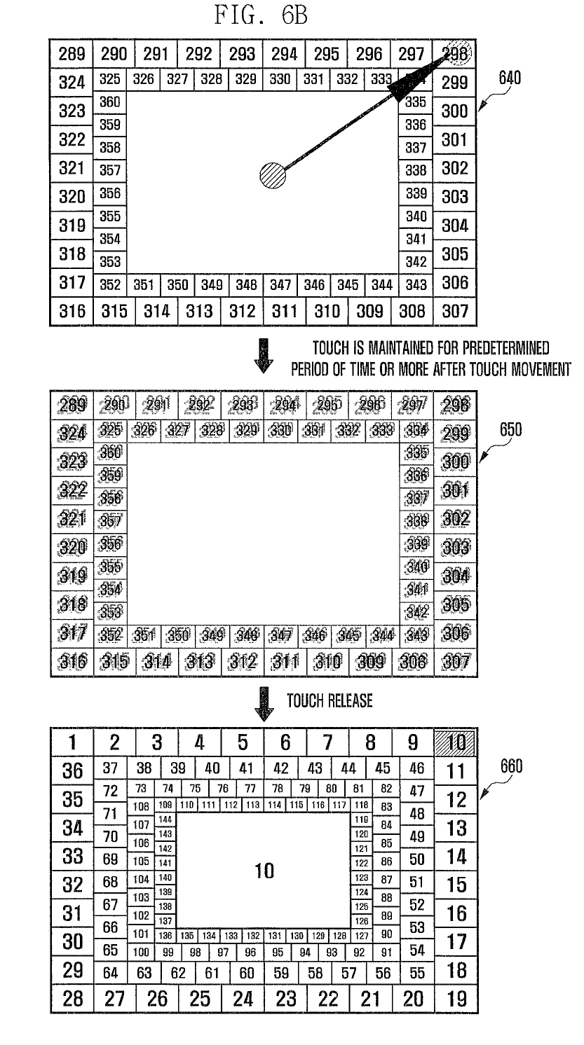

FIG. 6A illustrates an example of a screen for explaining a method of enlarging a content list screen according to another embodiment of the present disclosure, and FIG. 6B illustrates an example of a screen for explaining a method of reducing a content list screen according to another embodiment of the present disclosure.

Referring to FIGS. 6A and 6B, a controller 110 of an electronic device 100 according to an embodiment of the present disclosure may detect a touch movement event in a diagonal direction from the outside to the inside of the content list screen as illustrated in the drawing indicated by a reference numeral 610. When the touch is not released for a predetermined period of time or more after the touch movement in the diagonal direction from the outside to the inside of the content list screen, the controller 110 may continuously enlarge the screen as illustrated in the drawing indicated by a reference numeral 620. Thereafter, when a touch release event is detected, the controller 110 may stop the enlargement of the screen and may control a display unit 131 to output a screen at the time point when the touch release event is detected, as illustrated in the drawing indicated by a reference numeral 630.

On the other hand, when a touch is not released for a predetermined period of time or more after a touch movement event in a diagonal direction from the inside to the outside of a content list screen is detected, the controller 110 may continuously reduce the screen until the touch release event is detected, as illustrated in the drawings indicated by the reference numerals 640, 650, and 660.

A user can rapidly and conveniently control the enlargement/reduction of the screen through the aforementioned methods.

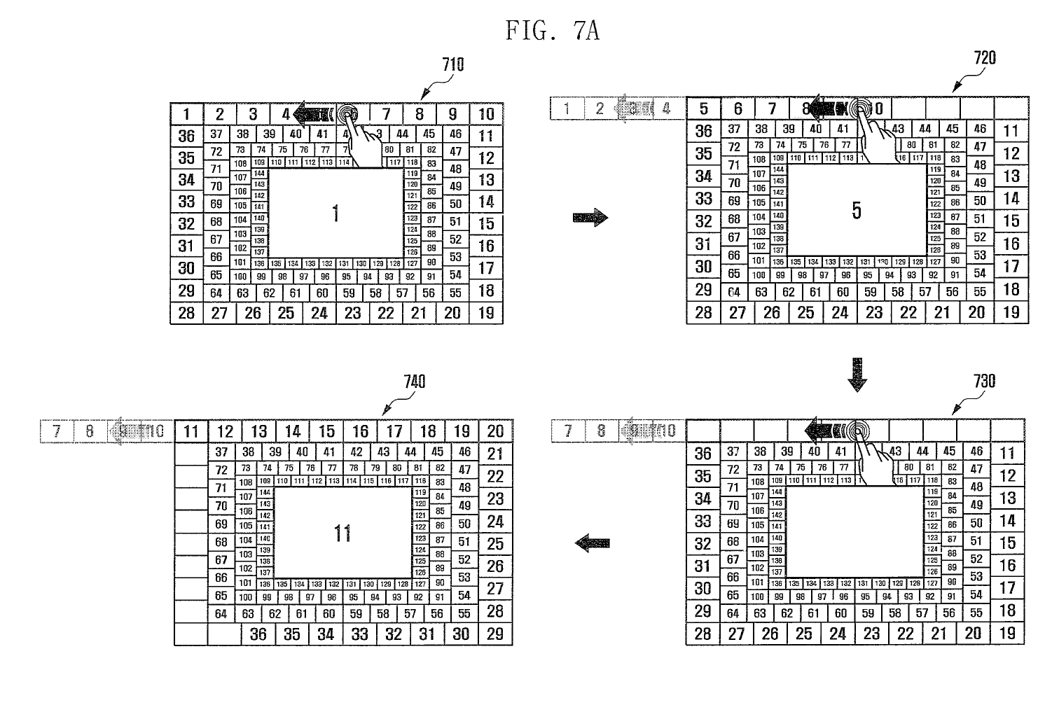

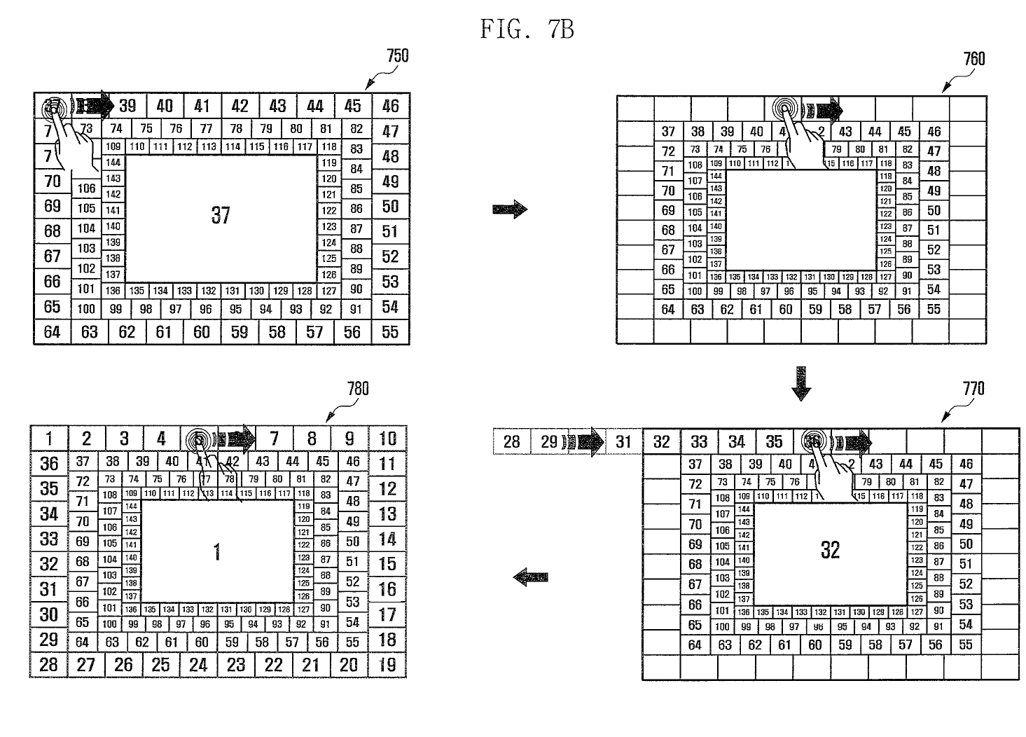

FIGS. 7A and 7B illustrate examples of a screen for explaining a method of moving content according to embodiments of the present disclosure.

Referring to FIGS. 7A and 7B, a controller 110 of an electronic device 100 according to an embodiment of the present disclosure may move icons in correspondence to an upward, downward, leftward, or rightward touch movement event (a drag, a flick, or the like).

First, a case of moving icons in a counterclockwise direction will be described with reference to FIG. 7A. When a leftward linear touch movement event is detected in the same state as in the drawing indicated by a reference numeral 710 of FIG. 7A, the controller 110 may move icons located in a first row (1st to 10th icons) leftward as illustrated in the drawing indicated by a reference numeral 720. At this time, the remaining icons (11th to 144th icons) may maintain a location thereof without being moved. When a touch movement event for moving icons is not detected for a predetermine period of time (e.g., 1 second) or more in the same state as in the drawing indicated by the reference numeral 720, the controller 110 may control a display unit 131 to move the whole of the remaining icons (the 11th to 144th icons). At this time, the controller 110 may fill an empty area in a fourth loop with icons subsequent to the 144th icon.

Meanwhile, when a leftward linear touch movement event is detected within a predetermined period of time in the same state as in the drawing indicated by the reference numeral 720, the controller 110 may move the icons located in the first row (5th to 10th icons) leftward.

When a leftward linear touch movement event is input in a state in which all the icons located in the first row are moved as illustrated in the drawing indicated by a reference numeral 730 of FIG. 7A, the controller 110 may move the remaining icons in the first loop (11th to 36th icons) as illustrated in the drawing indicated by a reference numeral 740.

Meanwhile, although not illustrated in FIG. 7A, the controller 110 may enlarge the screen by moving icons located in second to fourth loops (37th to 144th icons) to a location of the first to third loops, when all the icons located in the first loop (1st to 36th icons) are moved. Furthermore, in a case in which the last icon (e.g., the 144th icon) of the list is removed and thus, there is no icon to move, the controller 110 may inform a user of the fact through at least one of visual, aural, and tactile effects.

Next, a case of moving icons in a clockwise direction will be described with reference to FIG. 7B. When a rightward linear touch movement event is detected in the same state as in the drawing indicated by a reference numeral 750 of FIG. 7B, the controller 110 may reduce the screen as illustrated in the drawing indicated by a reference numeral 760. At this time, there are no icons in a first loop. When a touch movement event for moving icons is not detected for a predetermine period of time (e.g., 1 second) or more in the same state as in the drawing indicated by the reference numeral 760, the controller 110 may return to the previous state (the drawing indicated by the reference numeral 750). On the other hand, when the rightward linear touch movement event is detected within a predetermined period of time, the controller 110 may sequentially fill an empty space of the first loop by moving temporarily stored icons (1st to 36th icons) in a reverse order. The drawing indicated by a reference numeral 770 illustrates an example in which 32th to 36th icons are moved to correspond to the rightward linear touch movement event.

Meanwhile, when a touch event is not input for a predetermined period of time or more in the same state as in the drawing indicated by the reference numeral 770, the controller 110 may reconfigure the screen by moving the icons located in the second to fourth loops (37th to 144th icons) to the empty space of the first loop. The controller 110 may identify whether the 144th icon is the last icon, when reconfiguring the screen, and may display icons subsequent to the 144th icon (145th to 149th icons) in an empty space of the fourth loop, when the 144th icon is not the last icon.

When the icons are moved in the clockwise direction through the aforementioned operations and thus, a first icon is located at an upper left end of the screen as illustrated in the drawing indicated by a reference numeral 780 of FIG. 7B, the controller 110 may not move the icons anymore. At this time, the controller 110 may inform a user that the icons cannot be further moved, through at least one of visual, aural, and tactile effects. For example, the controller 110 may blur the screen, temporarily change a background color, output a pre-defined sound effect, or generate a vibration.

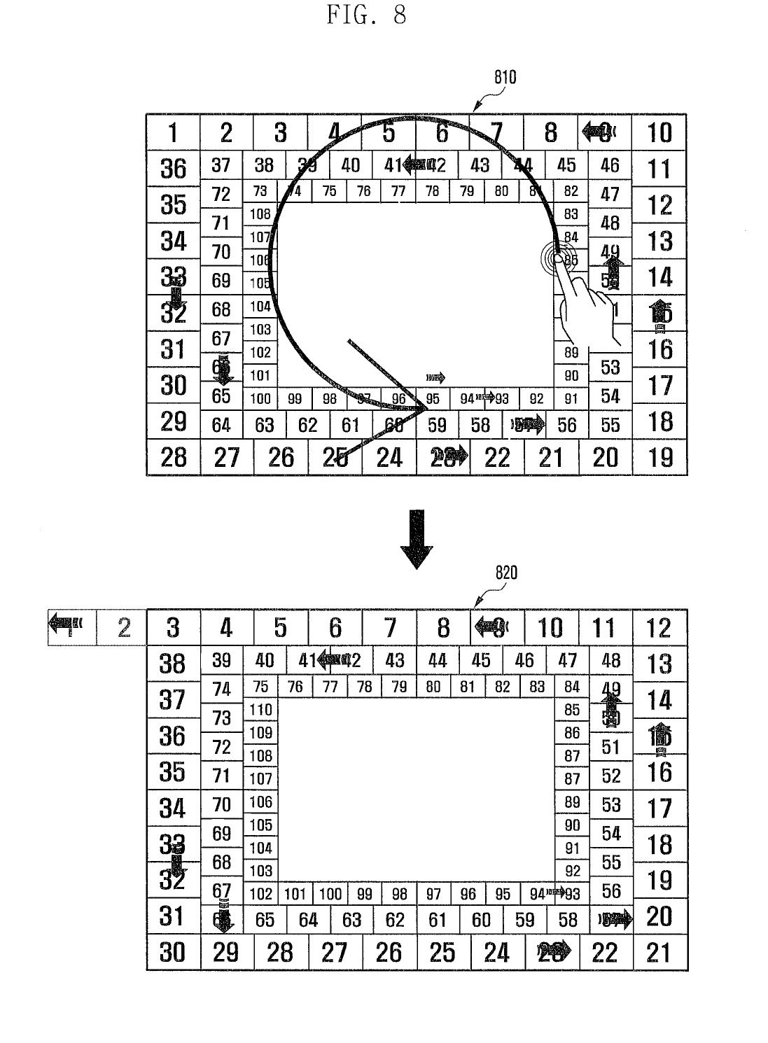

FIG. 8 illustrates a method of moving content according to another embodiment of the present disclosure.

Referring to FIG. 8, a controller 110 according to another embodiment of the present disclosure may continuously move all icons in correspondence to a pre-defined gesture (e.g., a circular gesture rotating in a clockwise or counterclockwise direction) . For example, when a counterclockwise circular gesture is input on a content list screen as illustrated in the drawing indicated by a reference numeral 810 of FIG. 8, the controller 110 may move icons as illustrated in the drawing indicated by a reference numeral 820. Referring to the drawing indicated by the reference numeral 820, it can be seen that first and second icons have been removed from the screen according to the counterclockwise circular gesture, and 109th and 110th icons have been added to the screen. The controller 110 may change the size of the icons when there is a request for changing the size of the icons. For example, it can be seen from the drawing indicated by the reference numeral 810 that icons located in a second loop (37th and 38th icons) are moved to a first loop to be increased in size and icons located in a third loop (73th and 74th icons) are moved to a second loop to be increased in size.

On the other hand, when a clockwise circular gesture is received, the controller 110 may move all icons in a clockwise direction.

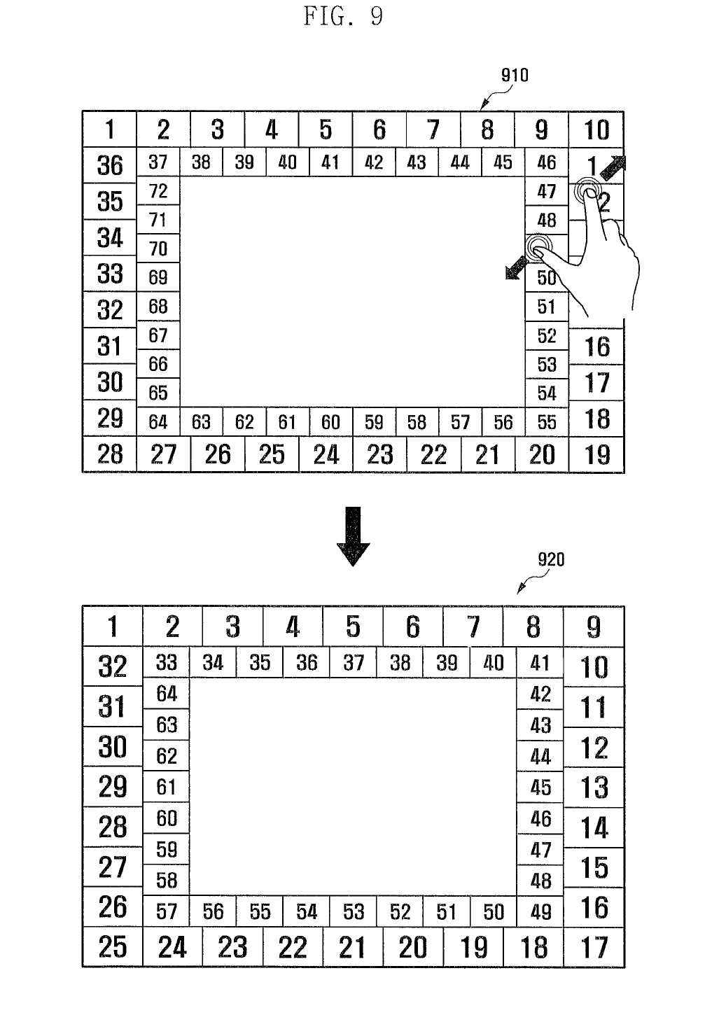

FIG. 9 illustrates a method of reconfiguring a content list screen by using a multi-touch according to an embodiment of the present disclosure.

Referring to FIG. 9, a controller 110 according to an embodiment of the present disclosure may reconfigure the content list screen in correspondence to a multi-touch event. Specifically, the controller 110 may reconfigure the screen by changing the number of icons included in each of loops when the multi-touch event is input. For example, as illustrated in the drawings indicated by reference numerals 910 and 920 of FIG. 9, the controller 110 may reconfigure the content list screen such that each of loops includes thirty two icons, when a stretch event occurs in a state in which the loop includes thirty six icons. To this end, the controller 110 may calculate a size of icons in a first loop by dividing a horizontal length (W, 1200) and a vertical length (H, 800) of the screen into nine equal parts. Thereafter, the controller 110 may determine that the icons in a second loop have a size corresponding to about 77.7% (=7/9*100) of the size of the icons in the first loop. At this time, referring to the drawing indicated by the reference numeral 920, it can be seen that the number of loops on the content list screen is maintained and 65th to 72th icons have been removed.

Although the total number of loops is maintained in FIG. 9 when the screen is reconfigured by the stretch event, the total number of loops may be changed at a time of reconfiguring the screen in another embodiment of the present disclosure. For example, when a stretch event is input on a screen configured with four loops, the controller 110 may reconfigure the screen and at the same time, may reduce the number of loops to three.

On the other hand, when a pinch event occurs, the controller 110 may increase the number of icons included in each of the loops. Similar to the stretch event, the controller 110 may maintain or increase the number of loops when reconfiguring the screen according to the occurrence of the pinch event.

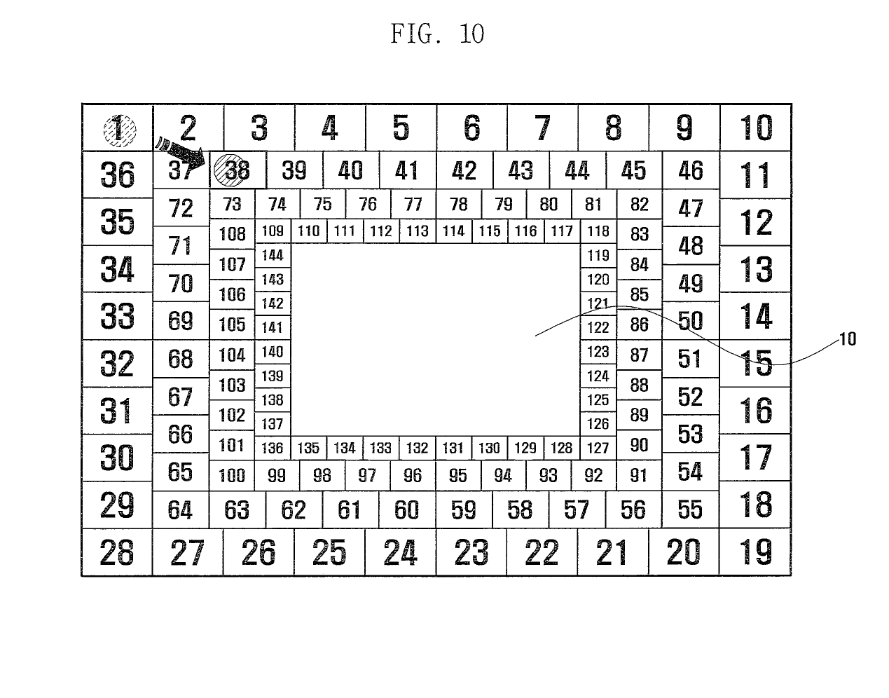

FIG. 10 illustrates a method of selecting a plurality of pieces of content on a content list screen according to an embodiment of the present disclosure.

Referring to FIG. 10, a controller 110 according to an embodiment of the present disclosure may receive a touch event for selecting a plurality of pieces of content on the content list screen. For example, when a user touches a 1st icon, moves the touch to a 38th icon, and releases the touch, the controller 110 may recognize that the user has selected the 1st to 38th icons. When the plurality of icons are selected as described above, the controller 110 may perform a slide show function for displaying the plurality of selected icons in a representative content display area 10 at a predetermined time interval. Furthermore, the controller 110 may generate a separate folder by cutting or copying the plurality of selected icons. However, the present disclosure is not limited thereto, and the controller 110 may perform various functions (e.g., a function of transmitting an icon, a function of deleting an icon, and the like).

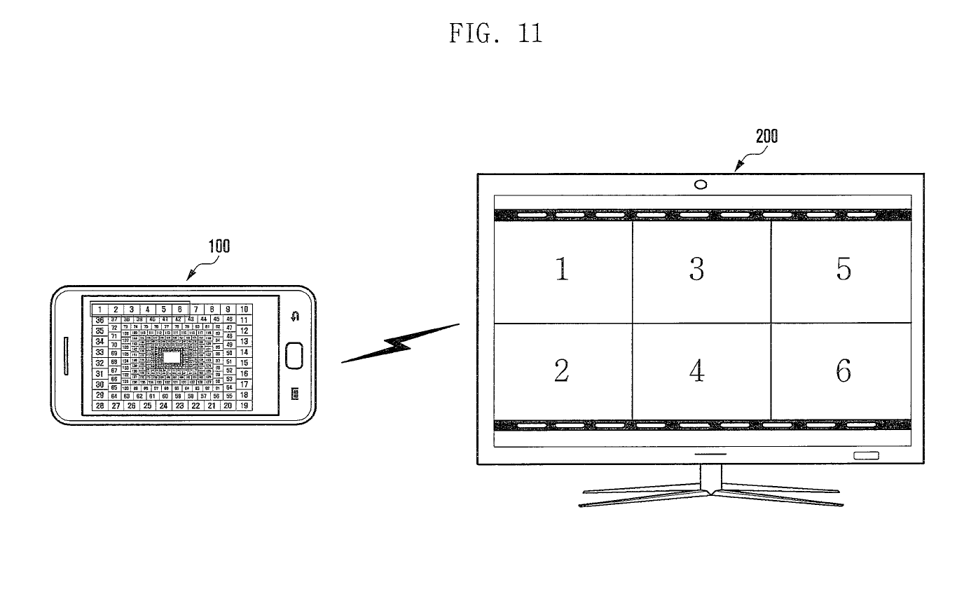

FIG. 11 illustrates a method of displaying a content list in conjunction with another electronic device according to an embodiment of the present disclosure.

Referring to FIG. 11, an electronic device 100 according to an embodiment of the present disclosure may display content in conjunction with another electronic device 200. The electronic device 200 may be a digital television (TV), a tablet Personal Computer (PC), or a monitor, which has a relatively large-sized screen.

The electronic device 100 may display the content list in the planar spiral structure as described above. Meanwhile, the electronic device 200 may arrange and display some (1st to 6th icons) of icons displayed in the electronic device 100 in the same size and in multiple rows and columns. The some icons maybe icons located in a pre-defined area (e.g., a display area illustrated by a dotted line box of FIG. 11).

According to the aforementioned embodiments of the present disclosure, an image search function can be rapidly provided through the electronic device 100, and in addition, icons can be provided to users in a familiar structure through the other electronic device 200. Furthermore, since the electronic device 200 has a relatively large-sized screen, the icons can be more easily identified.

The method of providing the user interface of the electronic device according to the aforementioned embodiments of the present disclosure may be implemented in a form of a program command which can be executed through various computer means and may be recorded in a computer-readable recording medium. The computer-readable recording medium may include a program command, a data file, and a data structure alone or a combination thereof. The program command recorded in the recording medium may be things specially designed and configured for the various embodiments of the present disclosure, or things that are well known to and can be used by those skilled in the computer software related art. The computer-readable recording medium includes magnetic media such as hard disks, floppy disks and magnetic tapes, optical media such as a Compact Disc Read-Only Memory (CD-ROM) and a Digital Versatile Disc (DVD), magneto-optical media such as floptical disks, and hardware devices such as a Read-Only Memory (ROM), a Random Access Memory (RAM) and a flash memory, which are specially configured to store and perform program commands. In addition, the program instructions may include high class language codes, which are executed in a computer by using an interpreter, as well as machine codes which are made by a compiler. The hardware devices may be configured to operate as one or more software modules to perform the operations of the present disclosure.

Although the method and the apparatus for managing the audio data of the electronic device according to the embodiments of the present disclosure have been described through the specification and drawings by using the specific terms, the embodiments and the terms are merely used as general meanings to easily describe technical contents of the present disclosure and assist understanding of the present disclosure, and the present disclosure is not limited to the embodiments. Although the present disclosure has been described with an exemplary embodiment, various changes and modifications may be suggested to one skilled in the art. It is intended that the present disclosure encompass such changes and modifications as fall within the scope of the appended claims.

What is claimed is:

1. A method of providing a user interface of an electronic device, the method comprising:
receiving a content list display request; and
outputting a content list screen on which icons corresponding to a plurality of pieces of content are arranged and displayed in a planar spiral structure.

2. The method of claim 1, wherein the content list screen comprises a plurality of loops, a size of the icons is changed in units of loops, and each of the loops is formed of the icons having a same size.

3. The method of claim 2, wherein arranging and displaying of the icons in the planar spiral structure comprises:
forming a first loop by arranging icons having a first size along an edge of a content display area; and
forming a second loop by arranging icons having a second size smaller than the first size by a predetermined rate when the icons having the first size are no longer arranged.

4. The method of claim 1, further comprising one of:
enlarging or reducing the content list screen according to a touch movement event of a diagonal direction input on the content list screen;
continuously performing enlargement or reduction of the content list screen until a touch is released, in a case in which the touch is moved in a diagonal direction and then is maintained for a predetermined period of time or more on the content list screen; and
enlarging the content list screen when a movement of the electronic device toward a user is detected, and reducing the content list screen when a movement of the electronic device away from the user is detected.

5. The method of claim 1, further comprising:
moving icons located in a specific loop in a counterclockwise direction according to a linear touch movement event for moving the icons in the counterclockwise direction;
rearranging the icons when the touch movement event is not detected for a predetermined period of time or more after at least some of the icons located in the specific loop are moved; and
enlarging the content list screen when all of the icons located in the specific loop are moved.

6. The method of claim 1, further comprising:generating an empty loop by reducing the content list screen when a linear touch movement event for moving the icons in a clockwise direction is detected;
moving the icons to the generated empty loop in correspondence to the linear touch movement event for moving the icons in the clockwise direction; and
rearranging the icons when a touch movement event is not detected for a predetermined period of time or more after the icons are moved to the empty loop.

7. The method of claim 1, further comprising:reconfiguring the content list screen by reducing the number of icons located in each of loops when a stretch event occurs on the content list screen; and
reconfiguring the content list screen by increasing the number of icons contained in each of the loops when a pinch event occurs on the content list screen.

8. The method of claim 7, further comprising:
reducing the number of loops when the stretch event occurs; and
increasing the number of loops when the pinch event occurs.

9. The method of claim 1, wherein the content list screen comprises a representative content display area.

10. The method of claim 1, wherein the content list screen comprises:
a first area in which the icons are arranged and displayed in the planar spiral structure; and
a second area in which some icons in the first area are displayed in a line.

11. The method of claim 1, further comprising:
applying a pre-defined function to icons between a specific icon and another icon when a touch is made for the specific icon on the content list screen, is moved to the other icon, and is released.

12. An apparatus for providing a user interface of an electronic device, the device comprising:
a storage configured to store a plurality of pieces of content;
a display configured to display an image; and
a controller configured to control the display unit to output a content list screen on which icons corresponding to the plurality of pieces of content are arranged and displayed in a planar spiral structure, when displaying of a content list is requested.

13. The apparatus of claim 12, wherein the content list screen comprises a plurality of loops, a size of the icons is changed in units of loops, and each of the loops is formed of icons having an a same size.

14. The apparatus of claim 13, wherein the controller is configured to form a first loop by arranging icons having a first size along an edge of a content display area, and form a second loop by arranging icons having a second size smaller than the first size by a predetermined rate when the icons having the first size are no banger arranged.

15. The apparatus of claim 12, wherein the controller is configured to move icons located in a specific loop in a counterclockwise direction according to a linear touch movement event for moving the icons in the counterclockwise direction, rearrange the icons when the touch movement event is not detected for a predetermined period of time or more after at least some of the icons located in the specific loop are moved, and enlarge the content list screen when all of the icons located in the specific loop are moved.

16. The apparatus of claim 12, wherein the controller is configured to generate an empty loop by reducing the content list screen when a linear touch movement event for moving the icons in a clockwise direction is detected, move the icons to the generated empty loop in correspondence to the linear touch movement event for moving the icons in the clockwise direction, and rearrange the icons when a touch movement event is not detected for a predetermined period of time or more after the icons are moved to the empty loop.

17. The apparatus of claim 12, wherein the controller is configured to reconfigure the content list screen by reducing the number of icons located in each of loops when a stretch event occurs on the content list screen, and reconfigure the content list screen by increasing the number of icons contained in each of the loops when a pinch event occurs on the content list screen.

18. The apparatus of claim 17, wherein the controller is configured to reduce the number of loops when the stretch event occurs, and increase the number of loops when the pinch event occurs .

19. The apparatus of claim 12, wherein the content list screen comprises a representative content display area.

20. The apparatus of claim 19, wherein the controller is configured to perform a slide show of icons between a specific icon and another icon by using the representative content display area when a touch movement event is detected in which a touch is made for the specific icon on the content list screen, is moved to the other icon, and is released.
